(19) United States
(12) Patent Application Publication
(10) Pub. No.: US 2025/0122075 A1
(43) Pub. Date: Apr. 17, 2025

(54) METHOD FOR SYNTHESIZING AMMONIA AND PLANT FOR PRODUCING AMMONIA

(71) Applicants: thyssenkrupp Uhde GmbH, Dortmund (DE); thyssenkrupp AG, Essen (DE)

(72) Inventor: Patrick KELLER, Luenen (DE)

(73) Assignees: thyssenkrupp Uhde GmbH, Dortmund (DE); thyssenkrupp AG, Essen (DE)

(21) Appl. No.: 18/694,613

(22) PCT Filed: Sep. 22, 2022
(86) PCT No.: PCT/EP2022/076432

§ 371 Date: Mar. 22, 2024

(30) Foreign Application Priority Data
Sep. 22, 2021 (BE) BE 2021/5747
Sep. 22, 2021 (DE) 10 2021 210 549.1

(51) Int. Cl. C01B 3/02; B01D 53/047; C01C 1/04; C25B 1/04; C25B 15/08

(52) U.S. Cl. CPC C01B 3/025; B01D 53/047; C01C 1/0405; C25B 1/04; C25B 15/081; B01D 2256/10; B01D 2257/104; C01B 2203/0233; C01B 2203/0244; C01B 2203/068; C01B 2203/1235; C01B 2203/142

(57) ABSTRACT

The disclosure relates to a process for producing ammonia. A hydrocarbon mixture and steam are supplied to a primary reformer. The hydrocarbon mixture and the steam are at least partly converted to carbon monoxide and hydrogen in the primary reformer. The gas mixture from the primary reformer is directed into a secondary reformer. The secondary reformer is supplied with process air, at least comprising oxygen and nitrogen, such that unconverted hydrocarbon is converted to carbon monoxide and hydrogen.

The invention relates to a process for producing ammonia, wherein a hydrocarbon mixture and steam are supplied to a primary reformer, wherein the hydrocarbon mixture and the steam are at least partly converted to carbon monoxide and hydrogen in the primary reformer, wherein the gas mixture from the primary reformer is directed into a secondary reformer, wherein the secondary reformer is supplied with process air, at least comprising oxygen and nitrogen, such that unconverted hydrocarbon is converted to carbon monoxide and hydrogen.

The invention additionally relates to a plant for production of ammonia, having at least a primary reformer for conversion of a hydrocarbon mixture and steam at least partly to carbon monoxide and hydrogen, having a secondary reformer for conversion of unconverted hydrocarbon to carbon monoxide and hydrogen, wherein the secondary reformer is fluidically connected to the primary reformer, wherein the secondary reformer is fluidically connected to a supply for process air, wherein the process air comprises at least oxygen and nitrogen.

Ammonia is one of the most important commodities. Global annual production is currently about 170 million tonnes. The majority of the ammonia is used for production of fertilizers. Industrial scale production nowadays uses mainly the high-pressure synthesis developed by Haber and Bosch at the start of the 20th century, in fixed bed reactors with iron as catalytically active main component, based on a synthesis gas of stoichiometric composition with hydrogen and nitrogen as its main components. The synthesis gas is produced predominantly by the natural gas route. A disadvantage here is the large amounts of carbon dioxide obtained.

The exothermic character of the ammonia formation gives rise to comparatively large amounts of heat in the course of the process. For good specific energy consumption of the overall process, these amounts of heat have to be utilized with maximum efficiency. In general, utilization of waste heat is associated with thermodynamically unavoidable losses. There has therefore been no lack of attempts to develop alternatives to the Haber-Bosch process that work without the high temperatures and pressures. In the Haber-Bosch process, the fundamental difficulty of activation of the very unreactive nitrogen molecule is overcome by the use of very active catalysts in combination with comparatively high temperatures. An alternative to the provision of the activation energy required is the use of electrical energy.

In order to save carbon dioxide, there are considerations of obtaining the raw materials, especially hydrogen, not via the natural gas route, or not completely. EP 2 589 426 A1 discloses, for example, a process for producing ammonia in which hydrogen is obtained from the electrolysis of water. Nitrogen can be obtained, for example, from a cryogenic air fractionation plant. The substances are mixed with one another and compressed to a pressure in the range from 80 to 300 bar.

From US 2021/198104 A1, a process for producing synthesis gas for ammonia production is known, in which air is fractionated in an air fractionation unit into an oxygen-containing substream and a nitrogen-containing substream (for example in a cryogenic fractional distillation, a membrane separation or a pressure swing adsorption), and a hydrogen-containing stream is additionally produced by electrolysis. In addition to the hydrogen-containing stream, the electrolysis produces a further stream containing oxygen. The oxygen-containing stream from the electrolysis, the oxygen-containing substream from the air fractionation and a hydrocarbon-based starting material are fed to an autothermal reformer or a secondary reformer, and hydrogen for the synthesis of ammonia is obtained from the product gas mixture therefrom. The nitrogen-containing substream and the hydrogen obtained in the reformer (where applicable, together with the hydrogen-containing stream from the electrolysis) are combined in a molar ratio of about 1:3 and fed to the reactor. For the autothermal reformer as well as for the secondary reformer, a gas mixture having an oxygen content which is higher in relative terms than its nitrogen content is required, and therefore, the oxygen produced in the electrolysis is used to enrich the process air with oxygen. As a result, the reforming can be conducted with a particularly high oxygen content, and nitrogen can be added only after the reforming (where applicable, together with the hydrogen-containing gas stream from the electrolysis). The use of the oxygen produced in the water electrolysis for partial oxidation in the reformer then makes it possible to reduce the size of the air separation unit.

In CN 101 580 234 B, a process for producing ammonia is described in which methane is converted in a steam reformer, and the product thus obtained is reacted with compressed process air in a downstream second reformer. In the steam reformer, for this purpose, oxygen-enriched process air is to be used in order to achieve a higher flame temperature, while nitrogen-enriched process air is used in the second reformer in order to reduce the amount of hydrogen which is combusted in the second reformer after production in the steam reformer. In order nevertheless to be able to assure high efficiency of the conversion of methane in the second reformer, the process air is instead heated more significantly in the preheater and hence the thermal load of the two-stage reforming is shifted from the second reformer to the preheater, which is heated by flue gas formed in the combustion of natural gas or coal and other fuels. For the process, overall, air is first compressed and the compressed air stream thus obtained is divided into two substreams. From the first substream, an oxygen-enriched air fraction is separated from a nitrogen-enriched air fraction using a hollow fiber membrane separation. The oxygen-enriched air fraction is fed to the first reformer, where it serves to reduce the surplus of air in the combustion of natural gas and to increase the flame temperature in the first reformer stage. The second substream of the compressed air stream is recombined with the nitrogen-enriched air fraction from the first substream, and the combined process air stream is heated in the preheater before being introduced into the second reformer. As a result, less hydrogen is combusted in the second reformer; at the same time, the process air fed in is more significantly heated in the preheater, as a result of which more hydrogen is finally obtained in the second reformer since less hydrogen is combusted therein. By means of the nitrogen-enriched air fraction, it is thus easily possible to adjust the desired ratio of hydrogen to nitrogen such that the raw materials used are more efficiently utilized; however, because of the higher fuel demand in the preheating of the process air upstream of the second reformer, this also leads to higher carbon dioxide emissions.

The invention relates to a process in which a portion of the hydrogen is obtained via the natural gas route and another portion from an external source (external hydrogen), such that less hydrogen has to be produced overall via the natural gas route. The problem here is that, although there is a decrease in the amount of hydrogen which is generated in the production of synthesis gas in what is called the front end of an ammonia plant, the amount of nitrogen to be added to the second reformer must remain constant as a first approximation. The nitrogen is supplied as process air containing at least nitrogen and oxygen. But this means that the secondary reformer is supplied with too much oxygen relative to hydrogen, which leads to the unwanted combustion of freshly obtained hydrogen. In order to counter this effect somewhat, it would likewise be necessary to increase the proportion of unreformed methane in the secondary reformer for the excess oxygen to be consumed in the conversion of methane. It would be possible to increase the proportion of unreformed methane in the secondary reformer by greatly reducing the firing output of the primary reformer. This would shift the reforming operation significantly from the primary reformer into the secondary reformer. However, with the amount of heat now available and at the resulting temperature level, it would no longer be possible to properly heat all the streams supplied in a flue gas duct at the front end.

It was therefore an object of the invention to provide a process for producing ammonia and an ammonia plant wherein the firing performance of the primary reformer remains virtually unchanged even in the case of reduction of the amount of hydrogen to be produced at the front end.

This object is firstly achieved by a process having the features of claim 1, in that the oxygen content of the process air is reduced before the process air is directed into the secondary reformer. By depletion of oxygen in the process air, the amount of heat released in the second reformer is reduced. Given a constant exit temperature from the secondary reformer, it is thus possible to increase the exit temperature from the primary reformer, firstly via the greater firing output, but also via the amount of heat available and the temperature level in the aforementioned flue gas duct. The oxygen content of the process air stream can be reduced, for example, by a nitrogen pressure swing adsorption.

In the process of the invention, the gas mixture from the secondary reformer is supplied (for instance via an outlet) to a reactor after further conditioning (processing, purification), hydrogen and nitrogen are at least partly converted to ammonia in the reactor, and external hydrogen is additionally supplied to the reactor. The external hydrogen can be introduced directly into the reactor. Instead, it is also possible to combine the gas mixture from the secondary reformer with the external hydrogen after further purification, and then to introduce the overall mixture thus obtained into the reactor. For this purpose, a further mixing unit disposed upstream of the reactor may be provided. But this is not absolutely necessary.

The further processing may especially include the conversion of the remaining carbon monoxide to carbon dioxide by means of steam and the separation of the carbon dioxide thus obtained from the flue gas, for example via a scrub or an absorption, and optionally also a reduction in the level of all oxygen-containing constituents to an envisaged minimum.

Advantageously, in one configuration of the process of the invention, the external hydrogen is produced by electrolysis. The hydrogen produced by electrolysis can contribute to an improvement in the environmental footprint of the process and hence the operation of an ammonia plant if “green” (renewably produced) and inexpensive power is available for utilization by the electrolysis. A further benefit of the process of the invention is that a hybrid mode of operation of an ammonia plant is possible to some degree. If clean power is available, hydrogen can be produced by electrolysis in the immediate vicinity of an ammonia plant, for example.

Accordingly, the depletion of the oxygen content of the process air can be matched to the hydrogen content available from the electrolysis or to the reduced hydrogen content at the front end of the ammonia plant.

In a further configuration of the process of the invention, the process air, upstream of the secondary reformer, is divided into at least a first substream and a second substream, in that the oxygen content of the first substream is reduced, and in that the first substream and the second substream are combined upstream of the secondary reformer. In this way, it is possible to adjust the oxygen content of the process air stream to the ideal level. For existing plants (to be retrofitted), the second substream can follow the original flow pathway, while it is merely necessary to install a branch into the existing pipeline system in order to treat the first substream.

In order to operate the process in a very advantageous manner, in a further configuration of the invention, the proportion of nitrogen in the first substream, in relation to the total amount of nitrogen in the reactor, corresponds to at least 43% of the proportion (molar proportion) of external hydrogen in relation to the total amount of hydrogen in the reactor. In order to ensure sufficient firing of the primary reformer, it is advisable that the capacity of the nitrogen pressure swing adsorption for the first substream in the total nitrogen demand (in the makeup stream to the synthesis gas compressor) must be at least half of the proportion of external (“green”) hydrogen (i.e. that obtained (entirely) with the aid of renewable energies). If, for example, 30% of the hydrogen from the front end is replaced by external hydrogen, the capacity of the nitrogen pressure swing adsorption should be at least 13.3% of the total nitrogen.

In addition, in a further configuration of the process of the invention, a multistage compression of the process air is provided, wherein the process air, between two compression stages, is divided into at least the first substream and the second substream. The first substream is consequently branched off downstream of a suitable stage of the process air compressor with regard to the pressure level, in order to achieve depletion of oxygen.

Between the compression stages, it is preferably the case, in a further configuration of the invention, that the process air, in a pressure range from 5 to 15 bara, is divided into at least the first substream and the second substream.

Moreover, in a further configuration of the process, it may be the case that the first substream and the second substream are combined again upstream of the last compression stage. After the last compression stage, the nitrogen-enriched air is supplied to the secondary reformer.

In a particularly advantageous configuration of the process of the invention, the first substream is supplied to a nitrogen pressure swing adsorption. In the physical separation process of pressure swing adsorption (PSA), individual gases are isolated from a gas mixture. The underlying principle is that gas molecules can be adsorbed on solids (more specifically, on the surface thereof). This solid, also called adsorbent, is designed accordingly for the respective use, in order that either only the component which is important in the particular application is adsorbed or only that component can penetrate the adsorbent. In the case of nitrogen pressure swing adsorption from process air, which may, for example, be ambient air and contains at least nitrogen and oxygen, the larger nitrogen molecule (in relation to kinetic diameter) can penetrate the adsorbent, whereas, in the pores, the smaller oxygen molecule penetrates into the pores of the adsorbent. In this case, the adsorbent used may preferably be a carbon molecular sieve.

Pressure swing adsorption can be divided into four steps that run cyclically. First of all, the untreated gas is directed into an adsorbent bed. Oxygen is adsorbed on the surface of the adsorbent or penetrates into the pores, while nitrogen is able to pass through the bed. This adsorption can continue until an equilibrium is attained. Thereafter, the pressure is lowered, which initiates regeneration of the adsorbent. The lowering of the pressure allows the adsorbed oxygen to become detached again from the surface and be discharged. For this purpose, in a further step, the adsorbent is purged with the product gas. This is followed by another pressure buildup until the necessary prerequisites for adsorption are satisfied again.

Advantageously, in a further configuration of the process, the first substream after the nitrogen pressure swing adsorption has a proportion by mass of nitrogen in the range from 0.9 to 1.0 (corresponding to 90% to 100%), preferably of 0.95 to 0.99 (corresponding to 95% to 99%). For nitrogen and oxygen, the masses of which differ by only 12.5%, the proportion by mass is identical to the molar proportion (in mol %) as a first approximation.

The aforementioned object is also achieved by a plant for production of ammonia, having at least a primary reformer for conversion of a hydrocarbon mixture and steam at least partly to carbon monoxide and hydrogen, having a secondary reformer for conversion of unconverted hydrocarbon to carbon monoxide and hydrogen, wherein the secondary reformer is fluidically connected to the primary reformer, wherein the secondary reformer is fluidically connected to a supply for process air, wherein the process air comprises at least oxygen and nitrogen. In addition, the secondary reformer is fluidically connected to a device for depletion of oxygen from the process air.

The secondary reformer need not be directly fluidically connected to the device for depletion of oxygen from the process air. It is also conceivable that further devices are disposed in the flow pathway between the device for depletion of oxygen from the process air and the secondary reformer.

The plant of the invention makes it possible to implement a process as claimed in any of claims 1 to 9. The above remarks regarding the process of the invention are correspondingly also applicable analogously to the plants of the invention for production of ammonia. Accordingly, the plant correspondingly additionally has a reactor for conversion of nitrogen and hydrogen at least partly to ammonia (i.e. for conversion of at least a portion of nitrogen and hydrogen to ammonia). The plant is supplied with external hydrogen via a corresponding flow pathway (hydrogen supply). The hydrogen supply is fluidically connected to the reactor, such that the external hydrogen can be introduced directly into the reactor. Instead, the gas mixture can be combined with the external hydrogen via the hydrogen supply from the secondary reformer after a further processing of the gas mixture, and the overall mixture thus obtained can then be introduced into the reactor. For this purpose, for example, the hydrogen supply may be fluidically connected to the secondary reformer downstream of the secondary reformer. For this purpose, a further mixing unit disposed upstream of the reactor may be provided. But this is not absolutely necessary.

In a first configuration of the plant of the invention, the device for depletion of oxygen from the process air comprises at least a nitrogen pressure swing adsorption. Thus, the depletion of oxygen can advantageously be conducted from the process air.

There is a multitude of specific ways of configuring and developing the process of the invention the plant of the invention. In this regard, reference is made to the claims dependent on claims 1 and 10 and to the description of preferred embodiments that follows in conjunction with the drawing. The figures show:

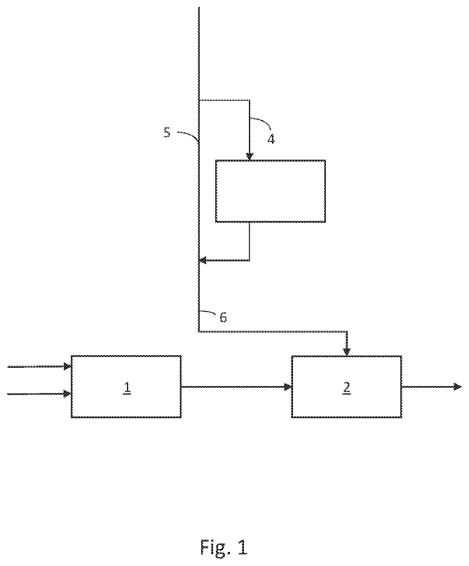

FIG. 1 a schematic diagram of a process of the invention for production of ammonia or of synthesis gas, and

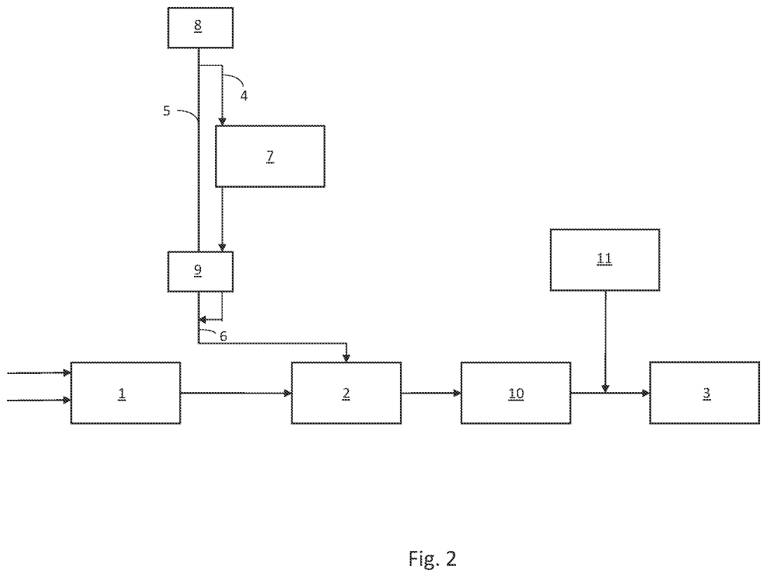

FIG. 2 a schematic diagram of an embodiment of a process for production of ammonia.

FIG. 1 shows a schematic diagram of the performance of a process for production of ammonia or for production of synthesis gas for further conversion to ammonia. This shows a primary reformer 1 and a second reformer 2 at what is called the front end of an ammonia plant. The synthesis gas can later be supplied to a reactor (not shown in FIG. 1).

The primary reformer 1, especially in the production of ammonia, is first used to produce hydrogen. For this purpose, in general, a hydrocarbon mixture, frequently methane, and steam are used as primary materials. In the case of utilization of natural gas, the main constituent of which is methane, other hydrocarbons are present as well. The natural gas is subjected to prior desulfurization and directed into the primary reformer. At temperatures between 700 and 850° C., methane is reacted with water under pressure over a nickel catalyst, so as to form carbon monoxide and hydrogen. The carbon monoxide additionally reacts further with steam to give carbon dioxide and further hydrogen. What is thus formed in the primary reformer 1 is a mixture of hydrogen, carbon monoxide, carbon dioxide, unconverted hydrocarbons, and steam.

The secondary reformer 2 is used to provide a mixture of hydrogen and nitrogen for the ammonia synthesis. The gas mixture from the primary reformer is mixed with compressed process air in the secondary reformer 2. The process air is preferably ambient air, which contains primarily nitrogen and oxygen. The oxygen content of the air reacts with the gas mixture which is supplied to the secondary reformer 2, which results in conversion of the unconverted methane or of the hydrocarbon mixture.

The nitrogen present in the process air does not react with the other substances and remains in the gas mixture. By controlling the amount of air introduced, it is possible to establish a desired ratio between hydrogen and nitrogen even in the secondary reformer 2.

If additional hydrogen, for example green hydrogen, is being used for later reactions, especially the reaction of hydrogen and nitrogen to give ammonia, the amount of hydrogen required from the primary reformer 1 or the secondary reformer 2 is smaller. But the amount of nitrogen from the process air remains roughly constant. If the amount of oxygen in the air supplied to the secondary reformer likewise remains unchanged, the reforming operation must be shifted significantly from the primary reformer 1 into the secondary reformer 2. For this purpose, the firing output of the primary reformer 1 must decrease significantly. With the amount of heat available as a result, it is impossible to sufficiently heat all the other streams required.

Therefore, in this embodiment of the process of the invention, the process air is divided into a first substream 4 and a second substream 5 before being directed into the secondary reformer 2 via a supply 6. The first substream 4 is sent to a device 7 for depletion of oxygen. In this way, the firing output of the primary reformer 1 is increased. The first substream 4 and the second substream 5 are combined again before being introduced into the secondary reformer 2.

FIG. 2 shows a further embodiment of the performance of a process for producing ammonia. As well as the primary reformer 1 and the secondary reformer 2, a device 7 is likewise provided for depletion of oxygen from the process air. The process air is compressed to the pressure required for the secondary reformer 2 by means of a multistage compression. Between a first compression stage 8 and a second compression stage 9, the first substream 4 is branched off from the second substream 5 and supplied to the device 7 for depletion of oxygen from the process air. The second compression stage 9 is the last compression stage in the process shown.

The device 7 for depletion of oxygen from the process air in this embodiment is a nitrogen pressure swing adsorption. In a nitrogen pressure swing adsorption, individual gases are isolated from a gas mixture. The principle is based on the ability of gas molecules to be adsorbed on solids. This solid, also called adsorbent, is designed accordingly for the respective use, in order that only the component which is important in the particular application is adsorbed, or only that component can penetrate the adsorbent. In the nitrogen pressure swing adsorption of process air, ambient air in this embodiment, the larger nitrogen molecule is able to penetrate the adsorbent, while the small oxygen molecule penetrates into the pores of the adsorbent. In this case, the adsorbent used is a carbon molecular sieve.

Since the nitrogen is able to flow through the adsorbent, nitrogen pressure swing adsorption affords a purified nitrogen stream. In this embodiment, the purity of the nitrogen leaving the nitrogen pressure swing adsorption is 95% to 100%. By adjusting the volume flow rates of the first substream 4 and the second substream 5, it is thus possible to correspondingly adjust the total nitrogen content.

The synthesis gas thus formed in the secondary reformer 2 is first processed before the ammonia synthesis can be conducted. For this purpose, in the block given the reference numeral 10, a conversion of the carbon oxides that otherwise act as catalyst poisons and would make the catalysts unusable in the synthesis is conducted. The rest of the carbon monoxide is converted to carbon dioxide by means of steam. The carbon dioxide is then separated from the untreated gas, for example by a scrubbing operation or an adsorption. Subsequently, all the oxygen-containing constituents (carbon monoxide, carbon dioxide, water) that are considered to be harmful to catalysts in the ammonia synthesis are reduced to an envisaged minimum, and what is called the makeup gas is compressed to synthesis pressure.

In the subsequent ammonia synthesis, in the reactor 3, hydrogen and nitrogen are converted to ammonia. As well as the hydrogen from the reforming, i.e. from the primary reformer 1 and the second reformer 2, additional hydrogen is directed into the reactor 3 from an external source via a hydrogen supply. The additional hydrogen in this embodiment is hydrogen produced from an electrolysis 11 of water. The electrolysis 11 can be utilized when inexpensive power is available, in order that the ammonia plant can be utilized in an economically viable manner.

In order to operate the process in a very advantageous manner, the proportion of nitrogen in the first substream 4, in relation to the total amount of nitrogen in the reactor 3, corresponds to at least 43% of the proportion of external hydrogen in relation to the total amount of hydrogen in the reactor 3. In order to ensure sufficient firing of the primary reformer, it is advisable that the capacity of the nitrogen content in the first stream 4 in the total nitrogen demand is at least 43% of the proportion of external (green) hydrogen. For example, if 30% of the hydrogen from the front end is being replaced by external hydrogen from the electrolysis 11, the capacity of the nitrogen content of the first substream is at least 13.3% of the total nitrogen.

### LIST OF REFERENCE NUMERALS

(1) primary reformer
(2) secondary reformer
(3) reactor
(4) first substream
(5) second substream
(6) supply
(7) device for depletion of oxygen
(8) first compression stage
(9) second compression stage
(10) processing
(11) electrolysis

1-11. (canceled)

12. A process for producing ammonia, the process comprising:
supplying a hydrocarbon mixture and steam to a primary reformer wherein the hydrocarbon mixture and the steam are at least partly converted to a gas mixture having carbon monoxide and hydrogen in the primary reformer;
directing the gas mixture from the primary reformer into a secondary reformer, supplying the secondary reformer with process air, at least comprising oxygen and nitrogen, such that unconverted hydrocarbon is converted to carbon monoxide and hydrogen; and
subsequent to further processing, mixing the gas mixture from the secondary reformer with external hydrogen and supplying to a reactor in which nitrogen and hydrogen are at least partly converted to ammonia;
wherein the oxygen content of the process air is reduced before the process air is directed into the secondary reformer.

13. The process as claimed in claim 12 wherein the external hydrogen is produced by electrolysis.

14. The process as claimed in claim 12 wherein the process air, upstream of the secondary reformer, is divided into at least a first substream and a second substream, in that the oxygen content of the first substream is reduced, and in that the first substream and the second substream are combined upstream of the secondary reformer.

15. The process as claimed in claim 14 wherein the proportion of nitrogen in the first substream, in relation to the total amount of nitrogen in the reactor, corresponds to at least 43% of the proportion of external hydrogen in relation to the total amount of hydrogen in the reactor.

16. The process as claimed in claim 14 wherein a multistage compression of the process air is provided, and in that the process air, between two compression stages, is divided into at least the first substream and the second substream.

17. The process as claimed in claim 16 wherein the process air, in a pressure range from 5 to 15 bara, is divided into at least the first substream and the second substream.

18. The process as claimed in claim 16 wherein the first substream and the second substream are combined again upstream of the last compression stage.

19. The process as claimed in claim 14 wherein the first substream is supplied to a nitrogen pressure swing adsorption.

20. The process as claimed in claim 19 wherein the first substream after the nitrogen pressure swing adsorption has a proportion by mass of nitrogen in the range from 0.9 to 1.0.

21. The process as claimed in claim 20 wherein the first substream after the nitrogen pressure swing adsorption has a proportion by mass of nitrogen in the range from 0.95 to 0.99.

22. A plant for production of ammonia, the plant comprising:
at least a primary reformer for conversion of a hydrocarbon mixture and steam at least partly to carbon monoxide and hydrogen;
a secondary reformer for conversion of unconverted hydrocarbon to carbon monoxide and hydrogen; and
a reactor for conversion of nitrogen and hydrogen at least partly to ammonia;
wherein the secondary reformer is fluidically connected to the primary reformer, wherein the secondary reformer is fluidically connected to a supply for process air, wherein the process air comprises at least oxygen and nitrogen, and wherein the plant has a hydrogen supply via which external hydrogen is one of (i) introduced directly into the reactor, and (ii) is combined with the gas mixture from the secondary reformer and the overall mixture thus obtained is then introduced into the reactor, wherein the secondary reformer is fluidically connected to a device for depletion of oxygen from the process air.

23. The plant as claimed in claim 22 wherein the device for depletion of oxygen from the process air comprises at least a nitrogen pressure swing adsorption.
